(19) United States
(12) Patent Application Publication
(10) Pub. No.: US 2009/0164155 A1
(43) Pub. Date: Jun. 25, 2009

(54) METHOD AND SYSTEM FOR ISOLATING DOPANT FLUCTUATION AND DEVICE LENGTH VARIATION FROM STATISTICAL MEASUREMENTS OF THRESHOLD VOLTAGE

(76) Inventors: KANAK B. AGARWAL, Austin, TX (US); Jerry D. Hayes, Georgetown, TX (US); Sani R. Nassif, Austin, TX (US)

Correspondence Address: IBM CORPORATION (MH);c/o MITCH HARRIS, ATTORNEY AT LAW, L.L.C., P.O. BOX 7998, ATHENS, GA, 30604, US

(21) Appl. No.: 11/961,520

(22) Filed: Dec. 20, 2007

(51) Int. Cl. G06F 17/18; G06F 19/00

(52) U.S. Cl. 702/65; 702/179

(57) ABSTRACT

A method and system for isolating dopant fluctuation and device length variation from statistical measurements of threshold voltage provides fast determination of process variation for devices in a characterization array. Statistics of threshold voltage are measured at two different values of drain-source voltage imposed on the devices in the characterization array. At least one moment of the a drain-induced barrier lowering (DIBL) coefficient η, which is a measure of device length and zero-bias threshold voltage V_{TH0} are computed directly from the statistical moment values of the threshold variation. The standard deviation and mean of η and V_{TH0} can thereby be obtained having only a statistical description of the threshold voltage for the devices in the array at multiple drain-source voltages. The threshold voltage statistics can be obtained from a digital meter measurement (rms and DC average) of a waveform indicative of threshold voltage produced by sequentially selecting the array devices.

### CROSS-REFERENCE TO RELATED APPLICATIONS

The present Application is related to U.S. patent application Ser. No. ______, Attorney docket No. AUS920070566US1 entitled “METHOD AND TEST SYSTEM FOR FAST DETERMINATION OF PARAMETER VARIATION STATISTICS”, filed contemporaneously herewith by the same inventors and assigned to the same Assignee. The present Application is also related to U.S. patent application Ser. No. 11/462,186 entitled “CHARACTERIZATION ARRAY AND METHOD FOR DETERMINING THRESHOLD VOLTAGE VARIATION”, filed on Aug. 3, 2006, and U.S. patent application Ser. No. 11/736,146 entitled “METHOD AND APPARATUS FOR STATISTICAL CMOS DEVICE CHARACTERIZATION”, filed on Apr. 17, 2006, each having at least one common inventor and assigned to the same Assignee. The disclosure of each of the above-referenced U.S. patent applications is incorporated herein by reference.

### BACKGROUND OF THE INVENTION

1. Field of the Invention

The present invention is related to device characterization methods, and more particularly to a method and system for determining transistor threshold voltage and device length variation from statistics of device parameter variations.

2. Description of Related Art

Parameter variation/process variation has become increasingly significant as processes have shrunk. Simulation can only provide a level of confidence in the overall yield of design or production, but testing is typically required to determine the true variation of device parameters for particular geometries and processes. For the reasons given above, test arrays are typically fabricated either on production wafers or as independent test models, to characterize devices for both design verification and production testing purposes. In particular, arrays and test methodologies have been developed for measuring threshold voltage variation within an array of devices.

However, threshold voltage variation arises from a number of factors, the predominant factors being variation in device length and variation in the dopant concentration. Since random variation is present in both device length and dopant concentration, measurements of threshold voltage do not completely describe the variation in the underlying factors. While other measurements can be taken to attempt to isolate device length variation from dopant-dependent threshold voltage variation, such measurements typically require discrete measurements of various operational characteristics for each device and computing the device length and dopant-dependent threshold voltage variation for each device. The above-described methodology is a time-consuming and computationally intensive process, especially when a large number of test devices must be evaluated.

Therefore, it would be desirable to provide a faster method and test system for determining device length variation and dopant-dependent threshold voltage fluctuation in an array of devices.

### SUMMARY OF THE INVENTION

The above objectives of providing a faster method and system for determining device length variation and dopant-dependent threshold voltage fluctuation for an array of devices is accomplished in a computer performed method and workstation computer, which may be a computer-controlled test system. The method is a method of operation of the computer system, which may be at least partially embodied in program instructions stored in computer-readable storage media for execution in a workstation computer system.

The computer system and method receive statistics describing threshold voltage variation for at least two different drain-source voltages applied to the devices in a characterization array. The statistics include the mean and standard deviation of the threshold voltage at each drain-source voltage. The mean and standard deviation of the drain-induced barrier lowering (DIBL) coefficient η and zero-bias threshold voltage V_{TH0} are computed directly from the threshold voltage statistics. A set of simultaneous equations relating the standard deviations of η and V_{TH0} to the standard deviations of the threshold voltage distribution at each of the drain-source voltages is solved to obtain the standard deviations η and V_{TH0}. Another set of simultaneous equations relating the mean of η and V_{TH0} to the mean of the threshold voltage distribution at each of the drain-source voltages is solved to obtain the mean of η and V_{TH0}. The device length variation can then be determined from a mapping function that relates ηV_{DS} to the device length.

The threshold voltage statistics may be obtained by a method and system that sequentially enable an array of devices in a characterization array under computer control. A test output from the array produces a voltage dependent on the threshold voltage. The sequentially activation of each device in the array produces a voltage waveform at the test output, which is then measured with a digital voltmeter interfaced to the computer. The rms value of the voltage provides an indication of the standard deviation of the threshold voltage, and the DC value of the voltage an indication of the mean of the threshold voltage. The measurements are repeated at multiple drain-source voltages applied to the devices in the characterization array.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1A is a schematic diagram of a transistor parameter characterization circuit, and FIG. 1B is a schematic of a transistor characterization array, that may be used in test methodologies and systems according to embodiments of the present invention.

FIG. 2 is a flow chart of a method in accordance with an embodiment of the present invention.

FIG. 3 is a pictorial diagram of a wafer test system in which methods in accordance with an embodiment of the present invention are performed.

### DETAILED DESCRIPTION OF PREFERRED EMBODIMENT

The present invention relates to a process/device characterization method and system that separate the threshold voltage variation due to device length variation and dopant fluctuation in an array of devices by directly transforming statistics of threshold voltage variation to statistics of DIBL coefficient η and zero-bias threshold voltage V_{TH0}. Threshold voltage variation statistics are provided for at least two different values of drain-source voltage for the array of devices. The threshold voltage statistics can be obtained by using a digital multi-meter, voltmeter and/or current meter to provide indications of standard deviation and/or mean values of the threshold voltage variation, as described in the above-incorporated U.S. patent application “METHOD AND TEST SYSTEM FOR FAST DETERMINATION OF PARAMETER VARIATION STATISTICS.” The method is a computer-performed method embodied in a computer program having program instructions for carrying out the method. The method and system may be embodied in a test workstation computer system that controls a characterization array and performs threshold voltage statistics measurements, which may be the multi-meter measurements described in the above-referenced U.S. patent application, or obtained by another means, such as collection of threshold voltage statistics by collecting statistics on measurement samples generated by the techniques described in the above-incorporated U.S. patent application “CHARACTERIZATION ARRAY AND METHOD FOR DETERMINING THRESHOLD VOLTAGE VARIATION.”

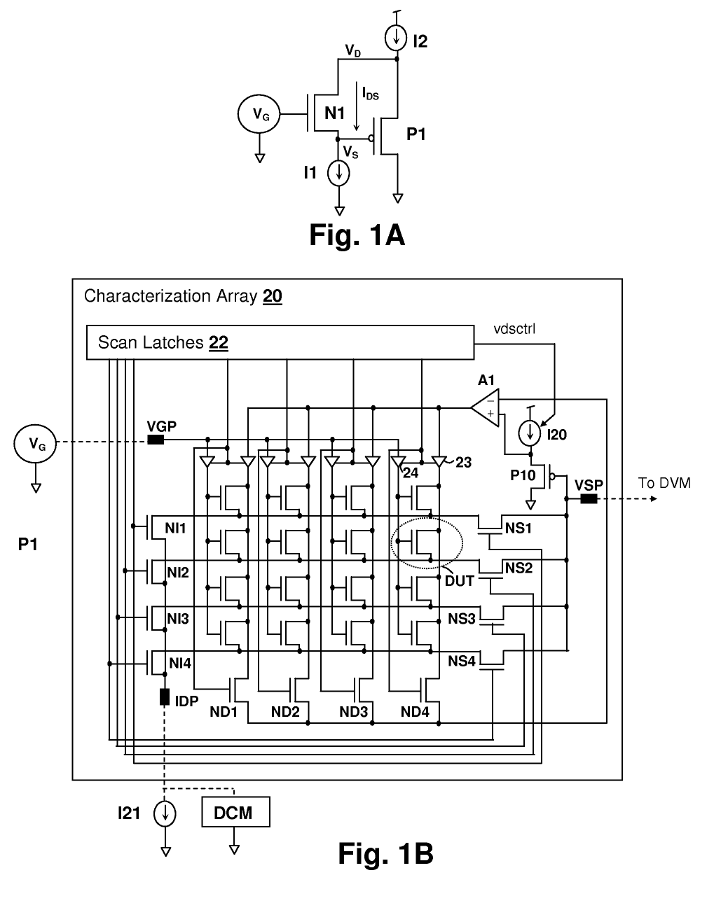

Referring now to FIG. 1A, a characterization circuit that may be used to obtain measurements used by methods in accordance with embodiments of the present invention is depicted. Transistor N1 is a device under test for which the threshold voltage V_{T} is to be determined. Transistor P1 and current source I2 form a source-follower that imposes a constant V_{DS} value across the channel of transistor N1, since the amount of current diverted through P1 is fixed by I1 and I2, any change in V_{S} results in an equal change in V_{D} in order to keep V_{GS} of P1 constant. Transistor P1 is generally a thick oxide device having a long channel and operated in the saturation region. Current source I1 fixes the channel current I_{DS} through transistor N1. A constant voltage V_{G} is imposed on the gate of transistor N1. Therefore, any variation in the threshold voltage (ΔV_{T}) of device N1 will appear directly as an opposite change in source voltage (ΔV_{S}) in the depicted measurement circuit, since ΔV_{G}=0, ΔI_{DS}=0 and therefore Δ(V_{GS}−ΔV_{T})=0.

Referring now to FIG. 1B, a characterization array 20 that may be used to obtain measurements used by methods in accordance with embodiments of the present invention is shown. Characterization array 20 is a test integrated circuit integrated on a die, a wafer kerf or other integrated circuit location that may be experimental only, or occupy one or more die or kerf locations in a production wafer. An array of transistors including device under test DUT is operated in a controlled manner via signals provided by scan latches 22. Although the exemplary embodiment uses scan latches 22 to apply the control signals, it is understood that registers controlled via a control interface or other suitable circuit may be provided to control the operation of characterization array 20. Further, it is understood that although the exemplary embodiment supplies signals to external equipment via pads VGP, IDP and VSP, one or more of the external devices used to operate and evaluate device under test DUT may be integrated within characterization array 20. For example, any or all of voltage source V_{G}, current source 121 and a voltage measurement circuit for measuring the voltage at pad VSP can be integrated on a wafer including characterization array 20.

Signals provided from scan latches 22 select a unique row and column associated with one of the transistors, e.g., device under test DUT. The selection of a row is made by a logical “1” applied to the gate of one of current steering transistors NI1-NI4 and simultaneously to a gate of a corresponding one of source voltage sense transistors NS1-NS4. Scan latches 22 are programmed such that only one row is selected at a time, i.e., all gates of transistors NI1-NI4 and NS1-NS4 are set to logical “0” other than the gates corresponding to the selected row. The selection of a column is made by enabling a transmission gate, e.g., transmission gate 24 that passes a reference gate voltage provided at pad VGP to the gates of all of the transistors in a column of the transistor array. A corresponding transmission gate 23 is also enabled and applies the output of amplifier A1 to the drain of each transistor in the selected column. The gate of a corresponding drain voltage sense transistor ND1-ND4 for the selected column is also set to a logic “1”, and provides a sense path for sensing the drain voltage of a column at the inverting input of amplifier A1. Scan latches 22 are sequentially programmed such that only one column is selected at a time, i.e., all transmission gates are disabled and drain voltage sense transistor ND1-ND4 gates are set to logical “0” other than the enabled transmission gates corresponding to the selected column and the gate of the corresponding rain voltage sense transistor ND1-ND4. The selection is performed at a constant rate and therefore a waveform of equal interval values corresponding to the threshold voltage V_{T} appears at output test point VSP. Sequential selection in the context of the present invention, does not mean that physical order must be maintained, only that the devices are selected in sequence so that their characteristics are reflected in the generated waveform(s).

The source follower circuit described with reference to FIG. 1A is included within characterization array 20, but includes amplifier A1, which forces the drain-source voltage (V_{DS}) to be a constant value for each selected transistor in the array. For example, when transistor DUT is selected by enabling transmission gates 23 and 24, along with transistors ND4, NI2 and NS2, transistor ND4 applies the drain voltage of transistor DUT to the inverting input of amplifier A1. Simultaneously, transistor NS2 applies the source voltage of transistor DUT to the gate of source-follower transistor P10, which controls the voltage at the non-inverting input of amplifier A1. The feedback loop acts to hold the drain-source voltage of transistor DUT constant by tracking any changes in the source voltage sensed from the selected row and adjusting the drain voltage supplied to the transistors in the column by an equal amount. Only one of the transistors in the array is conducting current at any time. Current provided from the output of A1 is directed through transmission gate 23 through the channel of transistor DUT and through transistor NI2 to an external stable current source I21. Since the current output of amplifier A1 is supplied to the drains of each transistor in a selected column, but only one selected row has a return path enabled via one of transistors NI1-NI4, only one device is selected for characterization for each valid combination of row and column selection signals provided from scan latches 22.

The above-described characterization array 20 thus provides a mechanism for sequentially selecting each device in the array and sensing changes in the source voltage V_{S} at pad VSP for a fixed operating point set by the channel current I_{DS} permitted through pad IDP and the gate voltage V_{G} applied at pad VGP. By setting different valid selection combinations in scan latches 22, each transistor in the array is selected and a value of V_{S} is measured and collected by a meter such as an external computer-controlled digital voltmeter (DVM) or digital multi-meter (DMM). Since at least two measurements must be performed at difference V_{DS} values, a mechanism for adjusting V_{DS} is provided within the characterization array of FIG. 1B. As shown, one or more bit values vdsctr1 provided from scan latches 22 can be used to select different values for current source 120, which will cause the value of V_{GS} of transistor P10 to change. Alternatively, current source 120 may be provided from an external current source via a test terminal (pad), and the external current source magnitude varied to adjust the drain-source voltage V_{DS} of transistor DUT. Since transistor P10 is a long-channel device, I_{DS} through transistor P10 is substantially independent of V_{DS} and therefore controlling I_{DS} through transistor P10 provides direct control of V_{GS} of transistor P10. As pointed out above, since the gate terminal of transistor P10 has a voltage equal to the source voltage applied to transistor DUT and the source terminal of transistor P10 is equal to the drain voltage applied to transistor DUT, controlling the magnitude of current source 120 provides a direct control of drain-source voltage V_{DS} of transistor DUT.

The present invention concerns the determination of statistical descriptions of dopant fluctuation and device length variation by separating their effects. The threshold voltage V_{T} of the devices is approximated as the sum of a zero-bias threshold voltage V_{TH0} and a DIBL-dependent threshold voltage variation ηV_{DS}, V_{T}=V_{TH0}+ηV_{DS}. Therefore the mean value (first statistical moment) of threshold voltage μ_{VT} is the sum of the mean values of V_{TH0} and ηV_{DS}, and V_{DS} was fixed for each measurement. Therefore, μ_{VT}=μ_{VTH0}+μ_{η}V_{DS}. Using two values of V_{DS} (V_{DS1}, V_{DS2}) as applied in the above-described measurements and the measured threshold voltage mean values (μ_{VTH1}, μ_{TH2}), the mean μ_{VTH0} of V_{TH0} and the mean μ_{η} of DIBL coefficient η can be determined by solving the following equation:

$$[ \begin{matrix}{μ}_{VTH 0} \\ {μ}_{η}\end{matrix} ] {\begin{matrix}= \\ =\end{matrix} [ \begin{matrix}1 & {Vds}_{1} \\ 1 & {Vds}_{2}\end{matrix} ]}^{- 1} [ \begin{matrix}{μ}_{VT 1} \\ {μ}_{VT 2}\end{matrix} ]$$

The standard deviation (second statistical moment) of zero-bias threshold voltage V_{TH0} and the standard deviation of DIBL coefficient η can be similarly obtained according to the relation σ²_{VT}=σ²_{VTH0}+σ²_{η}V_{DS}². Again using the two values of V_{DS} (V_{DS1}, V_{DS2}) as applied in the measurements and the threshold voltage standard deviations (σ_{VTH1}, σ_{TH2}), the standard deviation σ²_{VTH0} of V_{TH0} and the standard deviation σ²_{η} of DIBL coefficient η can be determined by solving the following equation:

$$[ \begin{matrix}{σ}_{VTH 0}^{2} \\ {σ}_{η}^{2}\end{matrix} ] \begin{matrix}= \\ =\end{matrix} [ \begin{matrix}1 & {Vds}_{1}^{2} \\ 1 & {Vds}_{2}^{2}\end{matrix} ] [ \begin{matrix}{σ}_{VT 1}^{2} \\ {σ}_{VT 2}^{2}\end{matrix} ]$$

μ_{VTH0} and σ_{VTH0} are the desired descriptors of the dopant fluctuation in the characterization array. However, μ_{η} and σ_{η} are only indirectly related to the device length variation. By using a mapping function η=F(L) based upon a device simulation model, the statistics μ_{η} and σ_{η} can be transformed to device length statistics μ_{L} and σ_{L} by computing (or using a look-up table) μ_{L}=F⁻¹(μ_{η}) and σ_{L}=F⁻¹(σ_{η}).

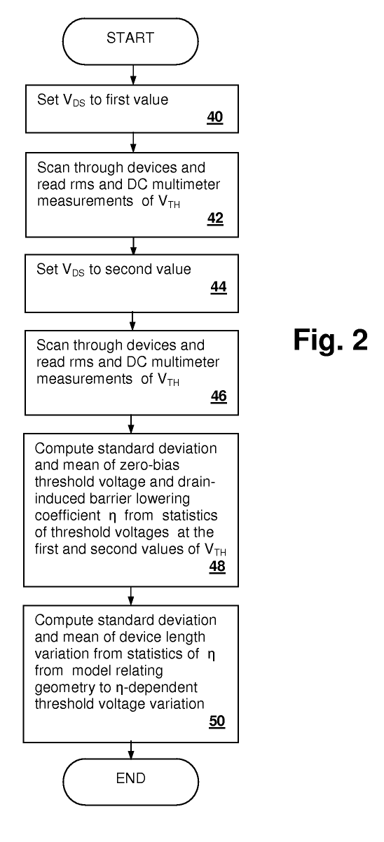

Referring now to FIG. 2, a method according to an embodiment of the invention is depicted in a flowchart. First, the test operating conditions for the characterization array are set, including power supply voltages and temperature and a first predetermined value for V_{DS} is set (step 40). Next, the devices are scanned and the rms and DC value of V_{TH} are obtained for the first V_{DS} value (step 42). A second predetermined value for V_{DS} is set (step 44), the devices are scanned and the rms and DC value of V_{TH} are obtained for the second V_{DS} value (step 46). The standard deviation and mean of zero-bias threshold voltage V_{TH0} and DIBL coefficient η are computed from the above relations (step 48) and finally, the device length variation is obtained from the model relating η-dependent threshold variation to device length (step 50).

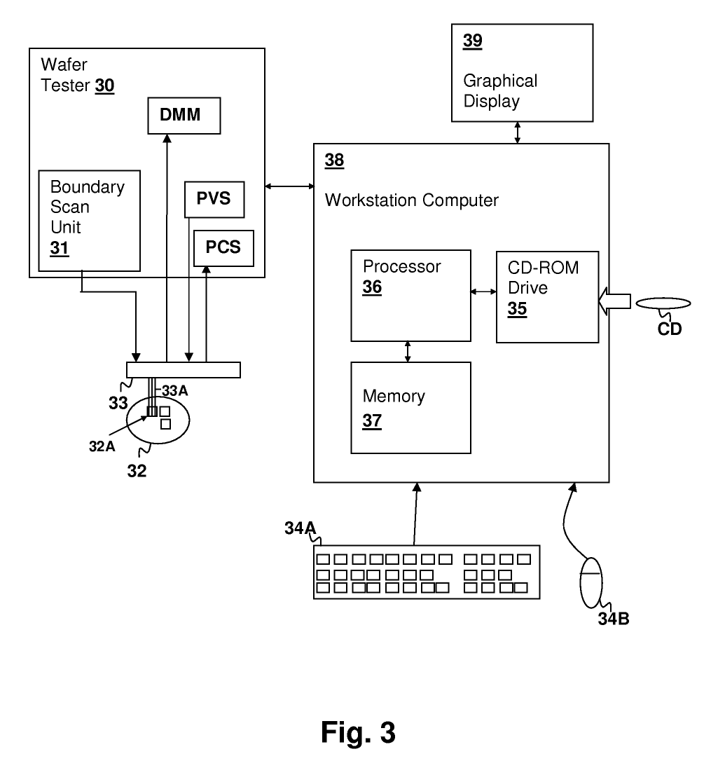

Referring now to FIG. 3, a wafer test system in which a method according to an embodiment of the invention is performed, is shown. A wafer tester 30 includes a boundary scan unit 31 for providing stimulus to a die or kerf circuit 32A on a wafer under test 32, via a probe head 33 having electrical test connections 33A to die 32A. Wafer tester 30 also includes a digital multi-meter DMM, which may be part of a parametric measurement unit that also includes a programmable voltage source PVS and a programmable current source PCS, that are all coupled to die 32A via probe head 33 electrical test connections 33A. The output of programmable voltage source is connected to pad VGP of FIG. 1, the output of programmable current source PCS is connected to pad IDP and the input of digital multi-meter DMM is connected to pad VSP.

A workstation computer 38, having a processor 36 coupled to a memory 37, for executing program instructions from memory 37, wherein the program instructions include program instructions for executing one or more methods in accordance with an embodiment of the present invention, is coupled to wafer tester 30, whereby the measurements described above are performed and measurements collected and stored in memory 37 and/or other media storage such as a hard disk. A CD-ROM drive 35 provides for import of program instructions in accordance with embodiments of the present invention that are stored on media such as compact disc CD. Workstation computer 38 is also coupled to a graphical display 39 for displaying program output such as distributions of the threshold voltage, V_{TH0}, η, and device length for devices in the characterization array provided by embodiments of the present invention. Workstation computer 38 is further coupled to input devices such as a mouse 34B and a keyboard 34A for receiving user input. Workstation computer may be coupled to a public network such as the Internet, or may be a private network such as the various “intra-nets” and software containing program instructions embodying methods in accordance with embodiments of the present invention may be located on remote computers or locally within workstation computer 38. Further, workstation computer 38 may be coupled to wafer tester 30 by such a network connection.

While the system of FIG. 3 depicts a configuration suitable for sequential test of a plurality of dies on a wafer, the depicted system is illustrative and not a limitation of the present invention. Probe head 33 may be a multi-die full wafer probe system, or may comprise multiple probe heads for simultaneously testing multiple wafers on a single or multiple die basis. Additionally, while boundary scan control of the characterization array is illustrated, the techniques of the present invention may also be applied to execution of test code from a processor incorporated on wafer 32 with appropriate current and voltage sources and voltage measurement circuitry provided on wafer 32, as well. The resultant generated display or data exported from workstation computer 38 may take the form of graphical depictions of the threshold voltage, V_{TH0}, η and device length variation across the characterization array, or may graphical or numerical statistical distribution information that describes the variations.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A computer-performed method for characterizing device length variation and dopant fluctuation in an array of devices, the method comprising:
first reading a first value of a statistical moment of threshold voltage for the array of devices at a first predetermined drain-source voltage into a memory of a computer system;
second reading a second value of the statistical moment of threshold voltage for the array of devices at a second predetermined drain-source voltage into the memory of the computer system;
computing, in the computer system, a statistical moment of a drain-induced barrier lowering coefficient and a statistical moment of a zero-bias threshold voltage from the first value and the second value, wherein the statistical moment of the drain-induced barrier lowering coefficient and the statistical moment of the zero-bias threshold voltage are of the same order as the statistical moment of threshold voltage; and
storing a result of the computing in the memory of the computer system.

2. The computer-performed method of claim 1, wherein the statistical moment of threshold voltage is a standard deviation of the threshold voltage.

3. The computer-performed method of claim 1, wherein the statistical moment of threshold voltage is a mean of the threshold voltage.

4. The computer-performed method of claim 3, further comprising:
third reading a third value of a standard deviation of threshold voltage for the array of devices at the first predetermined drain-source voltage;
fourth reading a fourth value of the standard deviation of threshold voltage for the array of devices at the second predetermined drain-source voltage; and
computing a standard deviation of the drain-induced barrier lowering coefficient and a standard deviation of the zero-bias threshold voltage from the third value and the fourth value.

5. The computer-performed method of claim 1, further comprising:
under control of the computer system, sequentially selecting devices within the array of devices as a selected device under test;
producing a voltage at a test output of the array of devices corresponding to a value of threshold voltage of the selected device, wherein a voltage or current waveform is generated at the test output;
measuring the voltage the waveform during the sequentially selecting with a digital meter interfaced to the computer system;
repeating the sequentially selecting, producing and measuring while forcing the drain-source voltage of the selected device under test to the first predetermined drain-source voltage and the second predetermined drain-source voltage.

6. The computer-performed method of claim 5, wherein the measuring measures an rms value of variation of the waveform as an indication of the standard deviation of the threshold voltage.

7. The computer-performed method of claim 1, further comprising computing statistics of the device length variation from the statistics of the drain-induced barrier lowering coefficient using a model relating device geometry to a threshold voltage variation dependent on the drain-induced barrier lowering coefficient.

8. A workstation computer system including a memory for storing program instructions for characterizing device length variation and dopant fluctuation in an array of devices, and a processor for executing said program instructions, wherein said program instructions comprise program instructions for:
first reading a first value of a statistical moment of threshold voltage for the array of devices at a first predetermined drain-source voltage into a memory of a computer system;
second reading a second value of the statistical moment of threshold voltage for the array of devices at a second predetermined drain-source voltage into the memory of the computer system;
computing a statistical moment of a drain-induced barrier lowering coefficient and a statistical moment of a zero-bias threshold voltage from the first value and the second value, wherein the statistical moment of the drain-induced barrier lowering coefficient and the statistical moment of the zero-bias threshold voltage are of the same order as the statistical moment of threshold voltage; and
storing a result of the computing in the memory.

9. The workstation computer system of claim 8, wherein the statistical moment of threshold voltage is a standard deviation of the threshold voltage.

10. The workstation computer system of claim 8, wherein the statistical moment of threshold voltage is a mean of the threshold voltage.

11. The workstation computer system of claim 10, wherein the program instructions further comprise program instructions for:
third reading a third value of a standard deviation of threshold voltage for the array of devices at the first predetermined drain-source voltage;
fourth reading a fourth value of the standard deviation of threshold voltage for the array of devices at the second predetermined drain-source voltage; and
computing a standard deviation of device length and a standard deviation of dopant fluctuation from the third value and the fourth value.

12. The workstation computer system of claim 8, further comprising an interface to the array of devices and a digital meter interfaced to the processor and coupled to a test output of the array of devices, and wherein the program instructions further comprise program instructions for:
sequentially selecting devices within said array of devices as a selected device under test, wherein the test output of the array of devices produces a voltage corresponding to a value of the threshold voltage of the selected device;
reading a measured voltage of the waveform from the digital meter after completion of the sequentially selecting; and
repeating the sequentially selecting and reading while forcing the drain-source voltage of the selected device under test to the first predetermined drain-source voltage and the second predetermined drain-source voltage.

13. The workstation computer system of claim 12, wherein the digital meter measures an rms value of variation of the waveform as an indication of the standard deviation of the threshold voltage and wherein the reading reads the rms value from the digital meter.

14. The workstation computer system of claim 8, further comprising program instructions for computing statistics of the device length variation from the statistics of the drain-induced barrier lowering coefficient using a model relating device geometry to a threshold voltage variation dependent on the drain-induced barrier lowering coefficient.

15. A computer program product comprising a storage media encoding program instructions for execution by a workstation computer system for characterizing device length variation and dopant fluctuation in an array of devices, wherein said program instructions comprise program instructions for:
first reading a first value of a statistical moment of threshold voltage for the array of devices at a first predetermined drain-source voltage into a memory of a computer system;
second reading a second value of the statistical moment of threshold voltage for the array of devices at a second predetermined drain-source voltage into the memory of the computer system;
computing a statistical moment of a drain-induced barrier lowering coefficient and a statistical moment of a zero-bias threshold voltage from the first value and the second value, wherein the statistical moment of the drain-induced barrier lowering coefficient and the statistical moment of the zero-bias threshold voltage are of the same order as the statistical moment of threshold voltage; and
storing a result of the computing in the memory.

16. The computer program product of claim 15, wherein the statistical moment of threshold voltage is a standard deviation of the threshold voltage.

17. The computer program product of claim 15, wherein the statistical moment of threshold voltage is a mean of the threshold voltage.

18. The computer program product of claim 17, wherein the program instructions further comprise program instructions for:
third reading a third value of a standard deviation of threshold voltage for the array of devices at the first predetermined drain-source voltage;
fourth reading a fourth value of the standard deviation of threshold voltage for the array of devices at the second predetermined drain-source voltage; and
computing a standard deviation of device length and a standard deviation of dopant fluctuation from the third value and the fourth value.

19. The computer program product of claim 15, wherein the workstation computer system includes an interface to the array of devices and a digital meter coupled to a test output of the array of devices, and wherein the program instructions further comprise program instructions for:
sequentially selecting devices within said array of devices as a selected device under test, wherein the test output of the array of devices produces a voltage corresponding to a value of the threshold voltage of the selected device;
reading a measured voltage of the waveform from the digital meter after completion of the sequentially selecting; and
repeating the sequentially selecting and reading while forcing the drain-source voltage of the selected device under test to the first predetermined drain-source voltage and the second predetermined drain-source voltage.

20. The computer program product of claim 15, further comprising program instructions for computing statistics of the device length variation from the statistics of a threshold voltage variation dependent on the drain-induced barrier lowering coefficient.
